(19) United States
(12) Patent Application Publication
(10) Pub. No.: US 2003/0123730 A1
(43) Pub. Date: Jul. 3, 2003

(54) Document recognition system and method using vertical line adjacency graphs

(76) Inventors: Doo Sik Kim, Daejeon (KR); Ho Yon Kim, Daejeon (KR); Kil Taek Lim, Daejeon (KR); Jae Gwan Song, Daejeon (KR); Yun Seok Nam, Daejeon (KR); Hye Kyu Kim, Seoul (KR)

Correspondence Address: JACOBSON HOLMAN PLLC, 400 SEVENTH STREET N.W., SUITE 600, WASHINGTON, DC, 20004, US

(21) Appl. No.: 10/329,392

(22) Filed: Dec. 27, 2002

(30) Foreign Application Priority Data
Dec. 29, 2001 (KR) 2001-88362

(51) Int. Cl. G06K 9/34

(52) U.S. Cl. 382/177

(57) ABSTRACT

In a document recognition system, a document structure analysis unit extracts a character image region from an input document image. A character string extraction unit extracts a character string image from the character image region. A character extraction unit extracts an individual character image from the character string image expressed in vertical lines by vertical line adjacency graphs by changing a pixel representation of the extracted character string image into a vertical line representation thereof. A character recognition unit recognizes each character in the individual character image and converting the recognized character into a corresponding character code.

### FIELD OF THE INVENTION

The present invention relates to a document recognition system; and, more particularly, to a document recognition system and a method thereof using vertical line adjacency graphs for estimating an image segmentation position and extracting an individual character image from a character string image based on the estimated image segmentation position.

### BACKGROUND OF THE INVENTION

A conventional document recognition system recognizes printed or hand-written characters and reads out the characters to perform a general data processing. Next, the read out characters are converted into corresponding character codes as an American Standard Code for Information Interchange (ASCII) code so that the data processing can be performed.

A recent document recognition system is being widely used in various electronic devices, since the system is able to greatly reduce a size of a user interface device or an amount of data to be transferred. Specifically, the document recognition system is used to recognize handwritten characters in a small-sized document recognition system, e.g., a PDA, having a hand-write key input interface instead of a keyboard. Further, when a document printed in a facsimile is transmitted, the document recognition system is used to recognize characters and only transmit character codes in order to reduce an amount of data to be transmitted.

Hereinafter, an operation of the document recognition system for recognizing characters in a printed document is described as follows. When a document to be recognized is inputted, the document recognition system scan-inputs a printed document image. Next, after the scan-inputted document image is divided into a character zone and a picture zone, a character string is extracted therefrom. Then, an individual character is extracted from the extracted character string to thereby recognize characters in the document.

In this case, a core technique in the conventional character recognition method is a process for extracting the individual character from the character string. In order to extract the individual character therefrom, a character segmentation position should be accurately estimated. Accordingly, there have been proposed various character segmentation position estimation methods using information such as vertical projection histograms, connected components, outlines and strokes.

However, the character segmentation method using the vertical projection histogram information has a drawback in that character segmentation becomes difficult in case strokes of characters are vertically overlapped. The character segmentation method using the connected component information has the same drawback in case strokes of characters are touched by each other. In the character segmentation method using the outline information, considerable processing time is spent in extracting the outline information and each character image from character string images. In the character segmentation method using the stroke information, processing time is considerably taken to extract the stroke information and each character image from the character string images. In addition to such problem, information on a thickness of the stroke, which is obtained from an input image, may be lost.

Meanwhile, the above-mentioned document recognition systems include “Noise removal from binary patterns by using adjacency graphs” disclosed on page 79 to 84 in volume 1 of “IEEE International Conference on Systems, Man, and Cybernetic” published on October in 1994, the U.S. Pat. No. 5,644,648 “Method and apparatus for connected and degraded text recognition” and “A new methodology for gray-scale character segmentation and recognition” disclosed on page 1045 to 1051 in volume 18 of “IEEE Transaction on Pattern Analysis and Machine Intelligence” published on December in 1996.

However, the “Noise removal from binary patterns by using adjacency graphs” shows a method for removing noise from a character image by using line adjacency graphs. The “Method and apparatus for connected and degraded text recognition” describes a method for consecutively extracting characteristics for word recognition instead of a character image by using horizontal line adjacency graphs. The “A new methodology for gray-scale character segmentation and recognition” provides a method for estimating character segmentation position information based on vertical projection histogram information of a gray-scale character image. Accordingly, the above-mentioned prior arts and techniques still have disadvantages in that it is difficult to extract an individual character image from a character image and accurately estimate a character segmentation position for the character image extraction.

### SUMMARY OF THE INVENTION

It is, therefore, an object of the present invention to provide a document recognition system and a method thereof for estimating an image segmentation position by using vertical adjacency graphs and accurately extracting a segment image based on the estimated image segmentation position when a segment image is extracted from an input image for an accurate extraction of an individual character.

In accordance with the present invention, there is provided a document recognition system including: a document structure analysis unit for extracting a character image region from an input document image; a character string extraction unit for extracting a character string image from the character image region; a character extraction unit for changing a pixel representation of the extracted character string image into a vertical line representation thereof and extracting an individual character image from the character string image expressed in vertical lines by vertical line adjacency graphs; and a character recognition unit for recognizing each character in the individual character image and converting the recognized character into a corresponding character code.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram of a document recognition system in accordance with a preferred embodiment of the present invention;

FIG. 2 illustrates a block diagram of a character extraction unit in accordance with a preferred embodiment of the present invention;

FIG. 3 provides a block diagram of a vertical line adjacency graph generation unit in accordance with a preferred embodiment of the present invention;

FIG. 4 present a block diagram of a vertical line set generation unit in accordance with a preferred embodiment of the present invention;

FIG. 5 represents a block diagram of an image segmentation position estimation unit in accordance with a preferred embodiment of the present invention;

FIG. 6 describes an example of a character string image expressed in vertical lines in accordance with a preferred embodiment of the present invention;

FIG. 7 offers an exemplary table of vertical line basic information in accordance with a preferred embodiment of the present invention;

FIG. 8 depicts an exemplary table of vertical line range table information in accordance with a preferred embodiment of the present invention;

FIG. 9 sets forth the an exemplary table of vertical line connection information in accordance with a preferred embodiment of the present invention;

FIG. 10 shows an exemplary table of vertical line adjacency graph information in accordance with a preferred embodiment of the present invention;

FIG. 11 illustrates an exemplary table of vertical line type information in accordance with a preferred embodiment of the present invention;

FIG. 12 describes an exemplary table of vertical line set composition information in accordance with a preferred embodiment of the present invention;

FIG. 13 depicts an exemplary table of vertical line set type information in accordance with a preferred embodiment of the present invention;

FIG. 14 presents an exemplary table of vertical line set composition information, which is modified when vertical line sets are merged, in accordance with a preferred embodiment of the present invention;

FIGS. 15 to 17 represent examples of character string images expressed in vertical line sets in accordance with a preferred embodiment of the present invention; and

FIG. 18 offers an example of an image segmentation path graph in accordance with a preferred embodiment of the present invention.

### DETAILED DESCRIPTION OF THE PREFERRED EMBODIMENTS

Preferred embodiments of the present invention will now be described in detail with reference to the accompanying drawings.

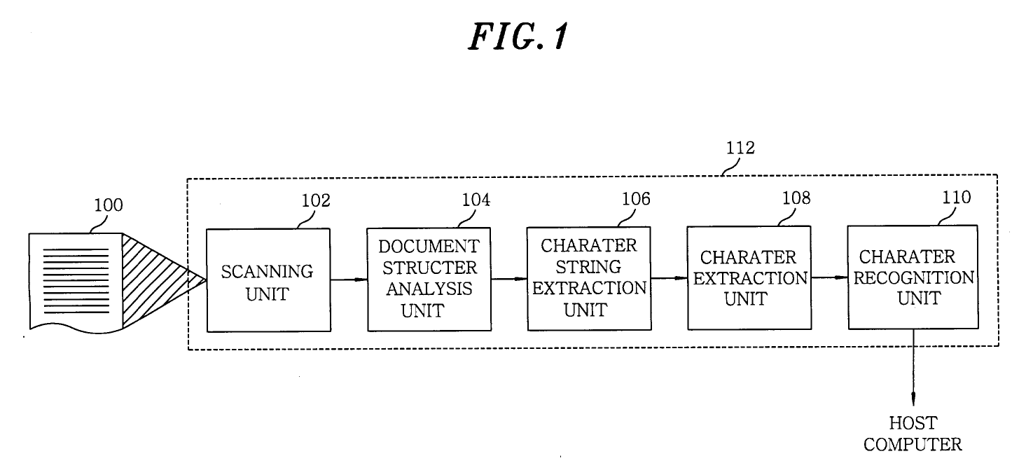

FIG. 1 shows a block diagram of a document recognition system in accordance with a preferred embodiment of the present invention. An operation of the document recognition system in accordance with the preferred embodiment of the present invention is described as follows.

A document structure analysis unit 104 divides a document image 100 scan-inputted through a scanning unit 102 into a character image region and a picture image region to extract the character image region therefrom. A character string extraction unit 106 extracts a character string image from the character image region extracted from the document structure analysis unit 104. A character extraction unit 108 extracts an individual character image from the character string image extracted from the character sting extraction unit 106.

When the individual character image is extracted therefrom in accordance with the preferred embodiment of the present invention, the character string extraction unit 106 vertically searches each pixel of the character string image to assign a certain range of values thereto and connects consecutive pixels, thereby expressing the pixels in a vertical line. Thereafter, the character string extraction unit 106 estimates an image segmentation position by using vertical line adjacency graphs. Based on the estimated image segmentation position, an individual character image is extracted from the character string image, and therefore, the segmentation position of the individual character image can be more accurately determined. A character recognition unit 110 recognizes each character in the individual character image provided from the character extraction unit 108 and converts the recognized character into a corresponding character code to thereby output the character code to a host computer.

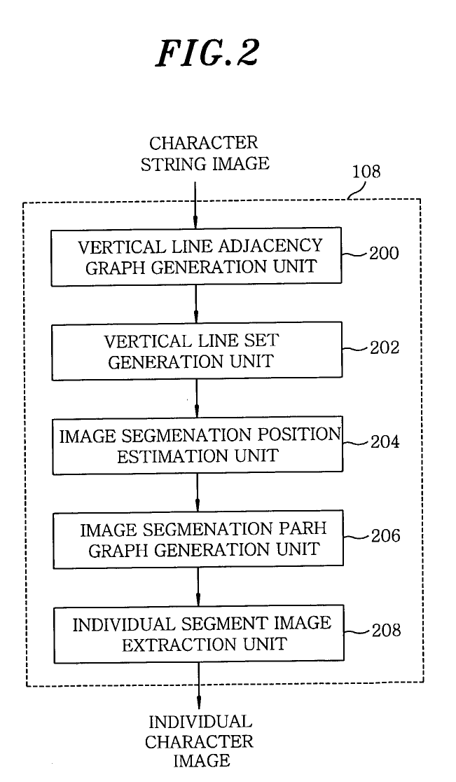

FIG. 2 illustrates a detailed block diagram of the character extraction unit 108 shown in FIG. 1 in accordance with a preferred embodiment of the present invention.

The character extraction unit 108 includes a vertical line adjacency graph generation unit 200, a vertical line set generation unit 202, an image segmentation position estimation unit 204, an image segmentation path graph generation unit 206 and an individual segment image extraction unit 208. Each operation thereof in the character extraction unit 108 is described as follows.

A character string image of an input document, which is extracted from the character string extraction unit 106, is provided to the vertical line adjacency graph generation unit 200 in the character extraction unit 108. The vertical line adjacency graph generation unit 200 generates vertical line adjacency graph information by using the input character string image provided from the character string extraction unit 108 and provides the generated information to the vertical line set generation unit 202. The vertical line adjacency graph is a new image expression method providing a simple image expression and an easy image analysis. To be specific, the conventional method expresses an image stored in a two-dimensional bit map on a pixel basis, but the new method using vertical line adjacency graphs expresses an image as vertical lines, i.e., a set of vertically adjacent black pixels, wherein the positional relations between the vertical lines are represented as graph information.

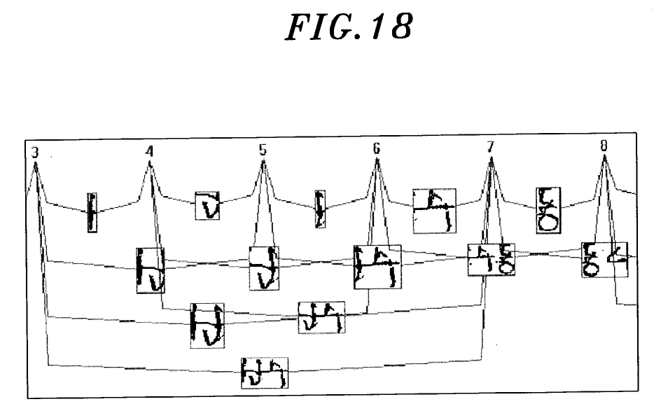

The vertical line set generation unit 202 generates vertical line set information on the character string image by using the vertical line adjacency graph information and then provides the generated information to the image segmentation position estimation unit 204. The image segmentation position estimation unit 204 estimates an image segmentation position for extracting an individual character image from the character string image by analyzing the vertical line set information and provides the estimated image segmentation position information to the image segmentation path graph generation unit 206. The image segmentation path graph generation unit 206 combines the image segmentation position information to generate an image segmentation path graph illustrated in FIG. 18 and provides the graph to the individual segment image extraction unit 208. The individual segment image extraction unit 208 extracts an individual character image corresponding to each path of the image segmentation path graph from the character string image expressed in vertical lines as shown in FIG. 18.

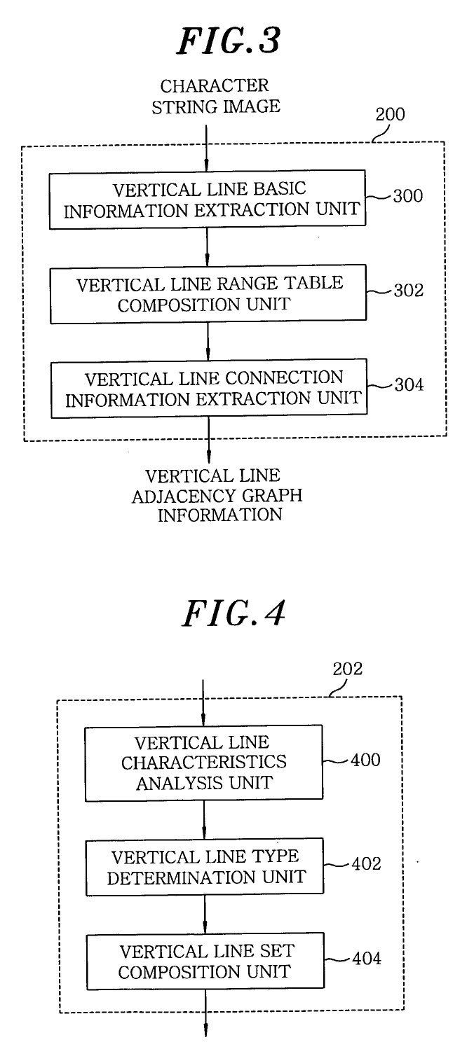

Hereinafter, operations of the vertical line adjacency graph generation unit 200, the vertical line set generation unit 202 and the image segmentation position estimation unit 204 in the character extraction unit 108 will be described in detail with reference to FIGS. 3 to 5.

FIG. 3 provides a detailed block diagram of the vertical line adjacency graph generation unit 200 in the character extraction unit 108, wherein the vertical line adjacency graph generation unit 200 includes a vertical line basic information extraction unit 300, a vertical line range table composition unit 302 and a vertical line connection information extraction unit 304.

The vertical line basic information extraction unit 300 converts a character string image expressed in the two-dimensional bit map as shown in (a) of FIG. 6 into an image expressed in vertical lines as shown in (b) of FIG. 6, and then extracts vertical line basic information from the image expressed in vertical lines. The vertical line basic information refers to column position information and top/bottom line position information for each vertical line identification (ID) assigned to each vertical line as shown in (c) of FIG. 6.

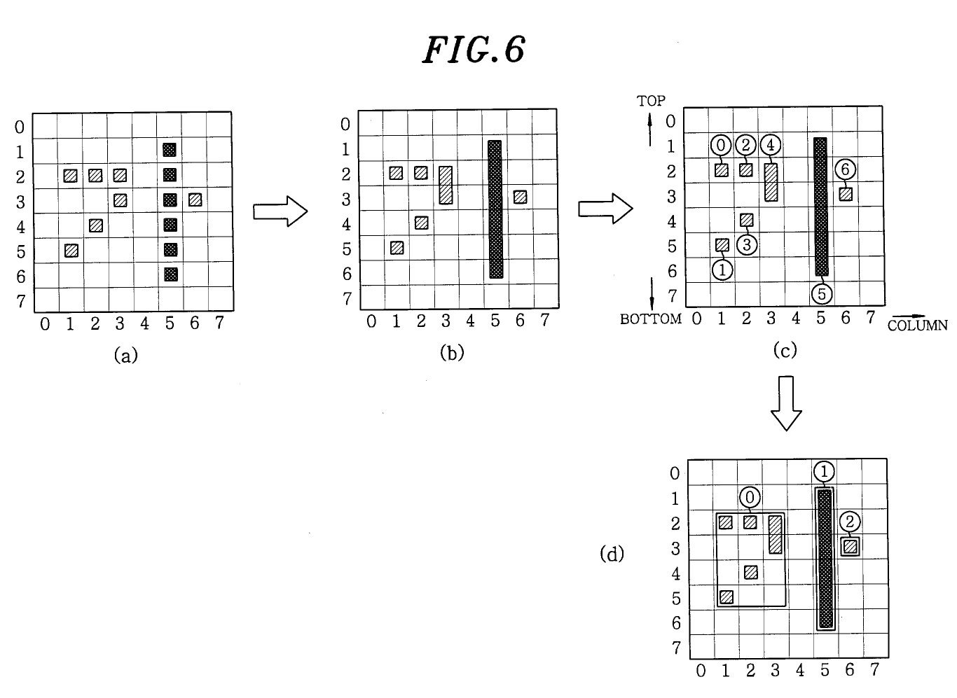

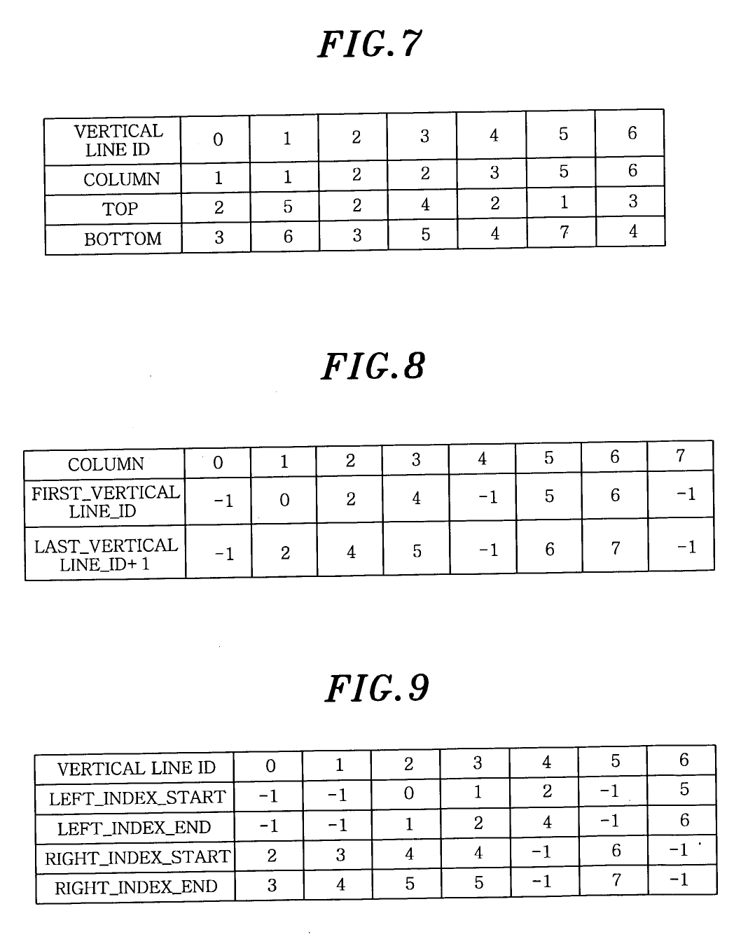

FIG. 7 shows an exemplary table of the vertical line basic information on the image expressed in vertical lines as illustrated in (c) of FIG. 6. For example, a vertical line having a vertical line ID “0” illustrated in (c) of FIG. 6 is located in a first column and a second top/bottom line of the character image, and therefore, a column position information value is recorded as “1” and top/bottom line position information values as “2” and “3”, respectively, as shown in FIG. 7. In this case, the bottom line position information value of the vertical line having the vertical line ID “0” is stored as “3”, which is an increased value of the original bottom line position information value “2” by “1”, to thereby easily calculate a length of the vertical line ID by using a difference between the top and the bottom line position information value.

A process for extracting the vertical line basic information is similar with a process for generating run-length encoding (RLE) images. However, there exists a difference in that a pixel is vertically searched, not in a horizontal direction, in the vertical line basic information extraction process. If an input image is not a binary image but a gray-scale image, when each pixel of the input image is searched, types of pixels can be determined based on a certain range of values, not a single value.

The vertical line range table composition unit 302 examines vertical line ID distributions on a column basis by retrieving vertical lines in each column of the image expressed in vertical lines, and then generates a table for illustrating vertical line range table information having information on the examined vertical line ID distributions. FIG. 8 depicts an exemplary table of the vertical line range table information, which records vertical line ID distributions on a column basis of the image expressed in vertical lines as illustrated in (c) of FIG. 6. For instance, since there exists no vertical line ID in a column “0” of the image expressed in vertical lines as shown in (c) of FIG. 6, “−1” is marked in a column “0” of the table illustrated in FIG. 8.

Vertical lines having vertical line IDs “2” and “3”, respectively, exist in a column “2” of the image expressed in vertical lines as shown in (c) of FIG. 6. Thus, vertical line ID “2” is marked in a column “2” of the table shown in FIG. 8 as a first vertical line ID information. The last vertical line ID information is recorded as “4”, which is the increased number of the last vertical line ID “3” by “1”, so that the number of vertical lines can be easily calculated.

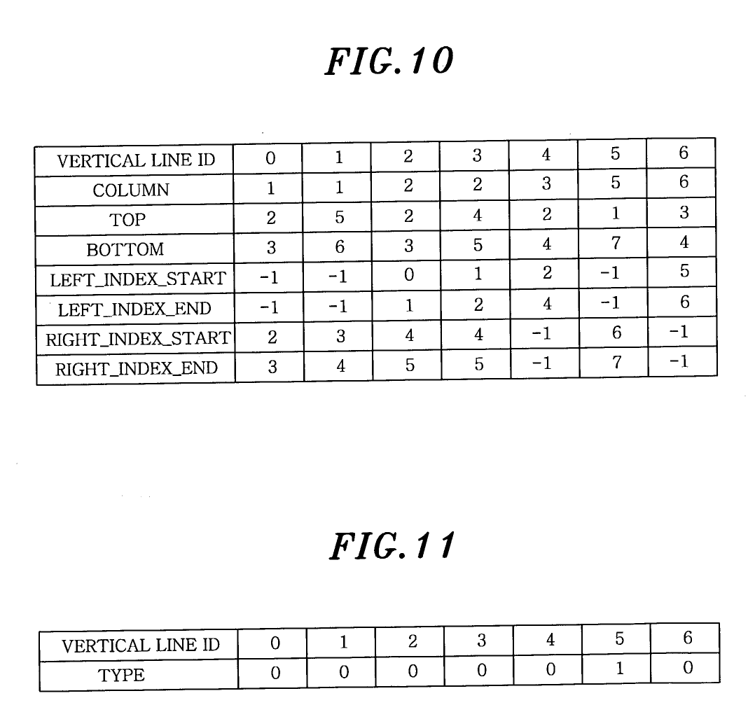

The vertical line connection information extraction unit 304 generates vertical line adjacency graph information, i.e., connection information between neighboring vertical lines in the image, by using vertical line information generated from the vertical line basic information extraction unit 300 and the vertical line range table composition unit 302. FIG. 9 sets forth an exemplary table of vertical line connection information, which records vertical line adjacency graph information representing a connection relation between left/right vertical lines having vertical line IDs shown in (c) of FIG. 6.For example, no vertical line is adjacent to the left of the vertical line having the vertical line ID “0” in the image expressed in vertical lines as shown in (c) of FIG. 6. Accordingly, a value of “−1” is marked in left_index_start/left_index_end of the vertical line having the vertical line ID “0” in the table illustrated in FIG. 9, wherein “−1” means that there exists no adjacent vertical line. Further, a vertical line having vertical line ID “2” is adjacent to the left of the vertical line having vertical line ID “0”, and therefore, “2” is marked in the right_index_start of the vertical line having vertical line ID “0”. And a value of “3”, which is an increased value of the vertical line ID “2” by “1”, is recorded in the right_index_end of the vertical line having vertical line ID “0”. Consequently, the vertical line adjacency graph generation unit 200 combines each information table generated from the vertical line basic information generation unit 300 and the vertical line connection information extraction unit 304 into a vertical line adjacency graph information table as shown in FIG. 10, and outputs the table. By using the vertical line adjacency graph information table, it is possible to find information on vertical lines in adjacent columns and to verify vertical lines vertically adjacent to the original vertical line. Such information can be usefully used when an individual character image is extracted from a character string image.

FIG. 4 presents a detailed block diagram of the vertical line set generation unit 202 in the character extraction unit 108, wherein the vertical line set generation unit 202 includes a vertical line characteristics analysis unit 400, a vertical line type determination unit 402 and a vertical line set composition unit 404.

The vertical line characteristics analysis unit 400 analyzes characteristics of vertical lines based on vertical line basic information extracted from the vertical line basic information extraction unit 300. For instance, when character segmentation is performed on Korean character string images, vertical line length information is provided to distinguish a vertical line dot, i.e., a vertical line crossing a horizontal stroke of a character, from a vertical line stroke, i.e., a vertical line parallel to a vertical stroke of a character. The vertical line type determination unit 402, in turn, determines the type of each vertical line based on the analyzed characteristics of the vertical line. In other words, the vertical line length information provided from the vertical line characteristic analysis unit 400 is used to check whether the vertical line is a vertical line dot or a vertical line stroke, to thereby determine the type of the vertical line.

FIG. 11 illustrates an exemplary table of vertical line type information generated from the vertical line type determination unit 402, which illustrates types of vertical lines corresponding to every vertical line ID shown in (c) of FIG. 6. To be specific, the vertical line type determination unit 402 compares a vertical line length for each vertical line ID shown in (c) of FIG. 6 with the predetermined threshold length to determine whether the vertical line is a vertical line dot or a vertical line stroke. Then, the type of the vertical line is recorded in the vertical line type information table illustrated in FIG. 11. In this case, the threshold length is predetermined as a length suitable for distinguishing the vertical line dot from the vertical line stroke or determined by statistical information on vertical line lengths. That is to say, in case the threshold length is predetermined to be the distance “3” between top and bottom position, a pixel of the vertical line ID “0” is shorter than the threshold length, and therefore, a logic value “0” representing the vertical line dot is recorded in the vertical line type information. Further, since a pixel of a vertical ID “5” is longer than the threshold length, a logic value “1” representing the vertical line stroke is recorded in the vertical line type information.

The vertical line set composition unit 404 searches vertical line adjacency graphs provided from the vertical line adjacency graph generation unit 200, and composes sets of vertical lines having the same vertical line type and connected with each other on a graph.

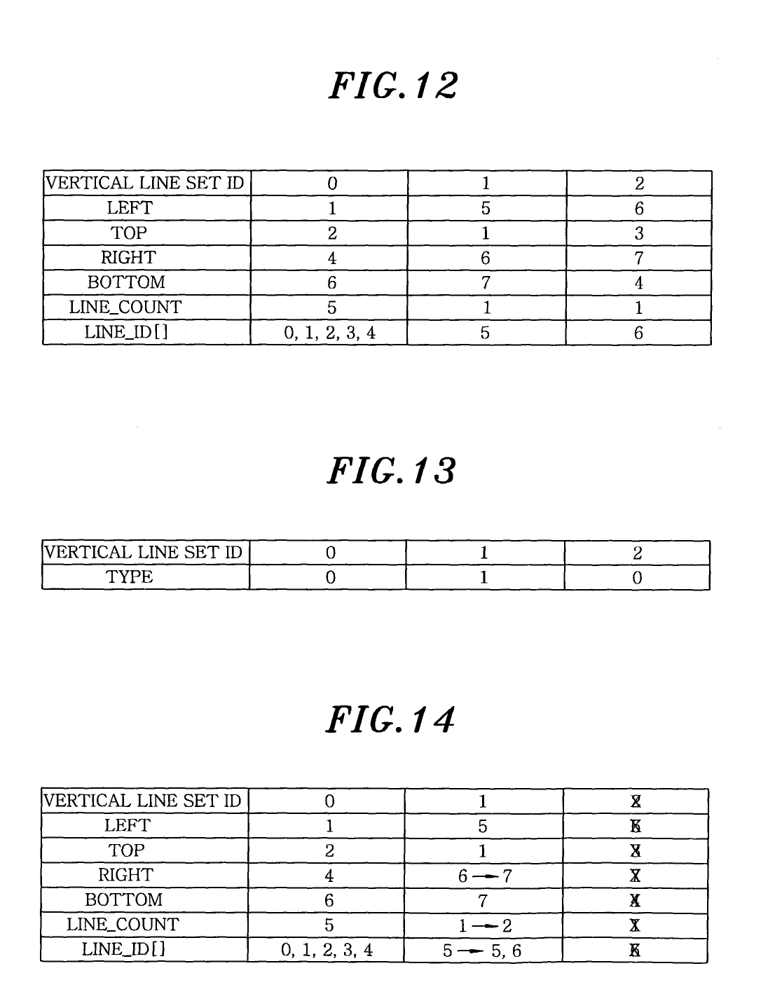

FIG. 12 describes an exemplary table of vertical line set composition information generated from the vertical line set composition unit 404, which records set composition information of vertical lines illustrated in (c) of FIG. 6.

Referring to FIG. 12, in case a vertical line set ID “0” is composed of vertical line IDs “0” to “4” in (c) of FIG. 6, vertical lines included in the vertical line set ID “0” are located in a quadrilateral zone ranging from column “1” to column “3” and from top line “2” to bottom line “5”. Thus, “1”, “2”, “4” and “6” are recorded as left, top, right and bottom position information corresponding to the vertical line set ID “0”, respectively, in the vertical line set ID information table. Further, the number of vertical line IDs (line_count) is “5”, and the vertical line ID information (line_id[ ]) corresponding to the vertical line set ID “0” are “0” to “5”. In this case, however, the right column position information and the bottom line position information are recorded as an increased value of each original information value by “1”, respectively. Accordingly, the resulting value of subtracting a left column position information value from a right column position information value represents a substantial width of a vertical line set region, and the resulting value of subtracting the top line position information from the bottom line position information represents a substantial height of the vertical line setregion.

Meanwhile, the vertical line set composition unit 404 pre-analyzes information on the size of the vertical line set and then predetermines the type of each vertical line set, so that the image characteristics can be analyzed easily for individual image extraction in the image segmentation position estimation unit 204.

FIG. 13 depicts an exemplary table of vertical line set type information representing vertical line set types of each vertical line set ID illustrated in (d) of FIG. 6, wherein the vertical line sets are generated by the vertical line set generation unit 202. Specifically, the vertical line set generation unit 202 compares the width and the height of each vertical line set illustrated in (d) of FIG. 6 with the predetermined threshold width and the predetermined threshold height. Next, it is checked whether the vertical line set corresponds to a vertical line stroke or not, and then a vertical line set type thereof is recorded in the vertical line set type information table shown in FIG. 13. In this case, the threshold width and the threshold height are predetermined as a length suitable for checking whether the vertical line set corresponds to a vertical stroke of a character or not, or determined by using statistical information on widths and heights of vertical line sets. For instance, the height of the zone of the vertical line set having vertical line set ID “0” is shorter than the predetermined threshold height, and therefore, a logic value “0” is recorded in the vertical line set type information, which means that the vertical line set is not a vertical stroke of a character. Further, the height of the zone of the vertical line set having vertical line set ID “1” is longer than the predetermined threshold height, so that a logic value “1” is recorded in the vertical line set type information, which means that the vertical line set is a vertical stroke of a character.

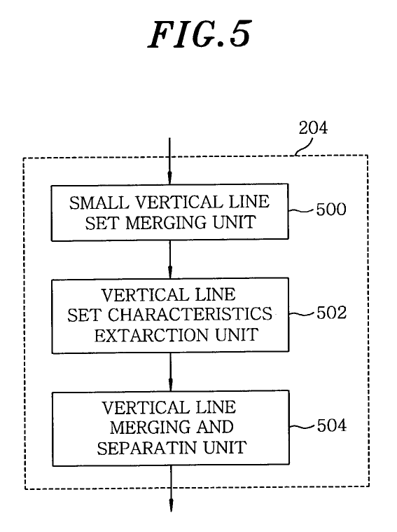

FIG. 5 represents a detailed block diagram of the image segmentation position estimation unit 204 in the character extraction unit 108, wherein the image segmentation position estimation unit 204 includes a small vertical line set merging unit 500, a vertical line set characteristics extraction unit 502 and a vertical line set merging and separation unit 504. The small vertical line set merging unit 500 analyzes the size of a vertical line set generated by the vertical line set generation unit 202 to check whether the vertical line set is a small vertical line set. Then, a small vertical line set is merged into an adjacent vertical line set.

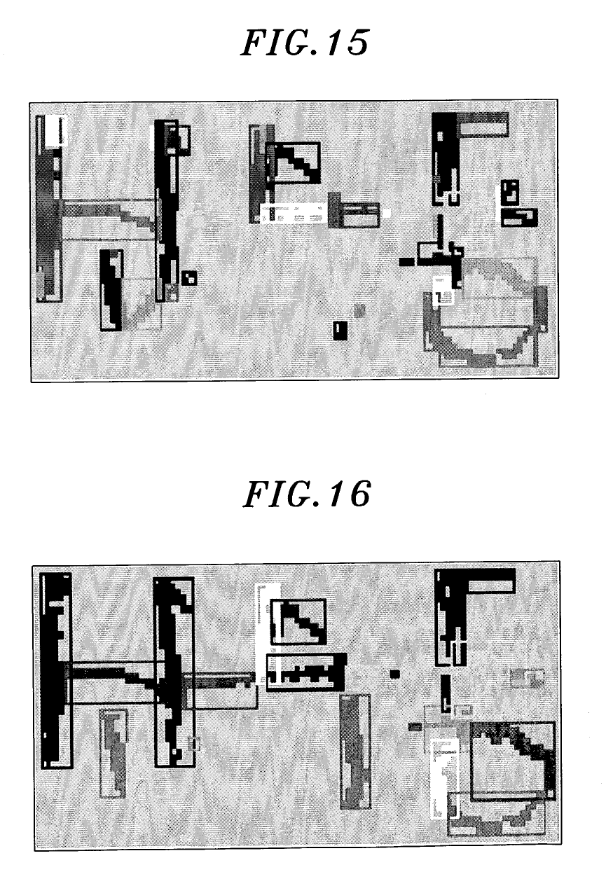

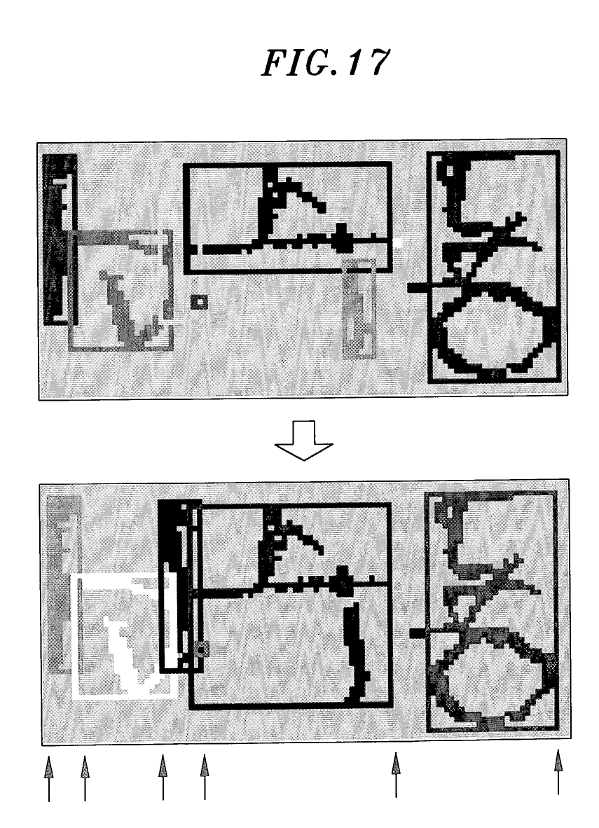

FIG. 16 shows the result of merging small vertical line sets in FIG. 15 into the vertical line set adjacent thereto. The vertical line set characteristics extraction unit 502 analyzes the information of the position, the size and the type of vertical line sets to extract the characteristics thereof, which information are obtained from the vertical line set composition unit 404. Then, images are merged or separated based on the extracted characteristics. The vertical line set merging and separation unit 504 merges or separates vertical line sets based on the characteristics extracted from the vertical line set characteristics extraction unit 502. The merging or separation of vertical line sets is performed by adding or deleting relevant vertical line IDs in the vertical line set information table of FIG. 12, and by increasing or decreasing the number of vertical lines (line_count). For example, in case two vertical lines of vertical line set IDs “1” and “2” in (d) of FIG. 6 are merged, the vertical line set information of the vertical line set ID “2” is merged into the vertical line set information of the vertical line set ID “1” as shown in FIG. 14, wherein the right column position information value is modified from “6” to “7”, and the number of vertical lines (line_count) and vertical line ID information (line_id[ ]) are changed from “1” to “2” and from “5” to “6”, respectively. Accordingly, the merging and separation of the image can be performed very rapidly.

When the vertical line set characteristics extraction unit 502 and the vertical line set merging and separation unit 504 perform character segmentation on, e.g., Korean character string images, the vertical line sets are sequentially searched from left to right. If a vertical line set is vertically overlapped with the following vertical line set at a ratio greater than a predetermined ratio, they are merged. Then, vertical line sets are considered to be part of character strokes. Next, by considering positional characteristics of the character strokes, broken character strokes are merged. As a result of repetition of the above processes, a character segmentation position is estimated. FIG. 17 illustrates a process for modifying a character string image expressed in vertical line sets, e.g., “ [symbol] ” shown in FIGS. 15 and 16, into individual character images by vertical line set merging and separation process of the vertical line set merging and separation unit 504.

Referring back to operations of the image segmentation path graph generation unit 206 and the individual segment image extraction unit 208 in the character extraction unit 108 of FIG. 2, the image segmentation path graph generation unit 206 regards each of vertical line sets generated in the image segmentation position estimation unit 204 as a candidate image of individual segment image. Then, the image segmentation path graph generation unit 206 tries to merge a certain range of vertical line sets from left, and then generates segment image candidate information. FIG. 18 depicts an example of an image segmentation path graph.

The individual segment image extraction unit 208 extracts image information from vertical line sets related with every path in the image segmentation path graph. The process for composing an image by using the vertical line sets is the inverse of the process performed by the vertical line basic information extraction unit 300. Specifically, a region to store the image is assigned in main memory and every pixel of the image is initialized in white. Thereafter, basic information on each vertical line is analyzed to modify pixels in the zone corresponding to the vertical line into black. An individual character image extracted from the individual segment image extraction unit 208 is provided to the character recognition unit 110 of FIG. 1, so that the character is recognized and converted into a corresponding character code.

As described above, the present invention has an advantage in that a size of information can be greatly reduced without losing image information, since a two-dimensionally bitmapped image is expressed as vertical line adjacency graphs in the process for extracting an individual character image from character string images inputted from a document recognition system. Further, the present invention is able to easily obtain character segmentation characteristics information for estimating character segmentation positions by using vertical line adjacency graphs, and also capable of easily and rapidly obtaining an individual character image based on the estimated character segment position. Therefore, character images can be extracted more rapidly and accurately when characters are extracted in the document recognition system, and the two-dimensionally bitmapped image can be rapidly restored from the image expressed in the vertical line adjacency graphs.

While the invention has been shown and described with respect to the preferred embodiments, it will be understood by those skilled in the art that various changes and modifications may be made without departing from the spirit and scope of the invention as defined in the following claims.

What is claimed is:

1. A document recognition system comprising:
a document structure analysis unit for extracting a character image region from an input document image;
a character string extraction unit for extracting a character string image from the character image region;
a character extraction unit for changing a pixel representation of the extracted character string image into a vertical line representation thereof and extracting an individual character image from the character string image expressed in vertical lines by vertical line adjacency graphs; and
a character recognition unit for recognizing each character in the individual character image and converting the recognized character into a corresponding character code.

2. The system of claim 1, wherein the character extraction unit further includes:
a vertical line adjacency graph generation unit for generating vertical line adjacency graph information by using the input character string image;
a vertical line set generation unit for generating vertical line set information on the character string image by using the generated vertical line adjacency graph information;
an image segmentation position estimation unit for analyzing the vertical line set information and estimating an image segmentation position for extracting the individual character image from the character string image; and
an individual segment image extraction unit for extracting an individual character image from the character string image expressed in vertical lines by using the estimated image segmentation position information.

3. The system of claim 1, wherein the character extraction unit further includes:
a vertical line adjacency graph generation unit for generating vertical line adjacency graph information by using the input character string image;
a vertical line set generation unit for generating vertical line set information on the character string image by using the generated vertical line adjacency graph information;
an image segmentation position estimation unit for estimating an image segmentation position for extracting an individual character image from the character string image by analyzing the vertical line set information;
an image segmentation path graph generation unit for generating image segmentation path graphs by combining the image segmentation position information; and
an individual segment image extraction unit for extracting each individual character image from the character string image expressed in vertical lines corresponding to every path in the image segmentation path graph.

4. The system of claim 2, wherein the vertical line adjacency graph generation unit further includes:
a vertical line basic information extraction unit for extracting vertical line basic information by sequentially searching each pixel in the input character string image;
a vertical line range table composition unit for recording range information of a vertical line ID representing each vertical line by retrieving vertical line information in each column from the vertical line basic information; and
a vertical line connection information extraction unit for generating connection information between vertical lines and neighboring vertical lines in adjacent columns by analyzing the extracted vertical line basic information.

5. The system of claim 4, wherein the vertical line connection information extraction unit generates vertical line connection information by checking whether or not each vertical line in the character string image is touched by neighboring vertical lines in adjacent columns.

6. The system of claim 4, wherein the vertical line basic information refer to position information of each vertical line in a character string image, i.e., a column coordinate value and a top/bottom line coordinate value of each vertical line in the input character string image converted into the vertical lines.

7. The system of claim 4, wherein the vertical line is generated by vertically searching each pixel in the input character string image and connecting a range of consecutive pixels in the image.

8. The system of claim 4, wherein the vertical line connection information refer to vertical line ID information of vertical lines adjacent to left/right of each vertical line in the input character string image converted into the vertical lines.

9. The system of claim 2, wherein the vertical line set information refer to vertical line ID group information (line_id) on groups composed of vertical lines having a connection relation each other in the input character string image converted into the vertical lines in accordance with the vertical line connection information.

10. The system of claim 9, wherein the vertical line set information further includes position information of a zone of a corresponding group in a character string image including the group of vertical line IDs.

11. The system of claim 10, wherein the group zone position information has a left top position information value and a right bottom position information value of a quadrilateral zone including the group of vertical line ID pixels in the character string image.

12. The system of claim 2, wherein the vertical line set generation unit further includes:
a vertical line characteristics analysis unit for generating vertical line characteristics information by using the vertical line information;
a vertical line type determination unit for determining types of vertical lines by using the vertical line characteristics information; and
a vertical line set composition unit for composing vertical line sets of vertical lines having similar vertical line types and adjacent to each other by analyzing the determined vertical line type and vertical line connection information.

13. The system of claim 12, wherein the vertical line type determination unit determines a vertical line type based on a predetermined threshold length in such a manner that a vertical line shorter than the threshold length is determined to be a vertical line dot and a vertical line longer than the threshold length is determined to be a vertical line stroke.

14. The system of claim 2, wherein the image segmentation position estimation unit further includes:
a vertical line set merging unit for merging a small vertical line set into an adjacent vertical line set by examining sizes of vertical line sets based on the vertical line set information provided from the vertical line set generation unit;
a vertical line set characteristics extraction unit for generating vertical line set characteristics information, i.e., a basic information for merging and separating vertical line sets, by examining characteristics of the merged vertical line sets; and
a vertical line set merging and separation unit for merging and separating vertical lines by analyzing the vertical line set characteristics information.

15. The system of claim 14, wherein the vertical line set characteristics extraction unit generates each vertical line set characteristics information of the merged vertical line sets by analyzing a position, a size, a shape, a connection relation and the like of each vertical line set.

16. The system of claim 3, wherein the image segmentation path graph generation unit generates vertical line sets representing segment image candidates obtained by variously combining the estimated image segmentation positions provided from the image segmentation position estimation unit, and also generates image segmentation path graphs based on combination of each image segmentation position.

17. The system of claim 2, wherein the individual segment image extraction unit extracts individual character image information from the character string image according to the image segmentation path graphs based on the image segmentation candidate positions, and outputs the extracted information.

18. A document recognition method using vertical line adjacency graphs in a document recognition system including a document structure analysis unit, a character string extraction unit, a character extraction unit and a character recognition unit, comprising the steps of:
(a) extracting a character image region from an input document image;
(b) extracting a character string image from the character image region;
(c) converting each pixel in the extracted character string image into vertical line information and extracting an individual character image from the character string image expressed in vertical lines by using vertical line adjacency graphs; and
(d) recognizing a corresponding character in the individual character image.

19. The method of claim 18, wherein the step (c) further comprises the steps of:
(c1) generating vertical line adjacency graph information based on the input character string image;
(c2) generating vertical line set information on the character string image by using the vertical line adjacency graph information;
(c3) estimating image segmentation position for extracting an individual character image from the character string image by analyzing the vertical line set information; and
(c4) extracting an individual segment image from the character string image by using the estimated image segmentation position information.

20. The method of claim 18, wherein the step (c) further comprises the steps of:
(c′1) generating vertical line adjacency graph information based on the input character string image;
(c′2) generating vertical line set information on the character string image by using the vertical line adjacency graph information;
(c′3) estimating image segmentation position for extracting an individual character image from the character string image by analyzing the vertical line set information;
(c′4) generating image segmentation path graph by combining the image segmentation position information; and
(c′5) extracting each of individual character image from the character string image expressed in vertical lines corresponding to every path in the image segmentation path graph.

21. The method of claim 20, wherein the step (c′1) further comprises the steps of:
(c′11) extracting vertical line basic information by sequentially searching each pixel in the input character string image;
(c′12) composing range information of a vertical line ID representing each vertical line by retrieving vertical line information in each column from the vertical line basic information; and
(c′13) generating connection information between each vertical line and neighboring vertical lines in adjacent columns by analyzing the vertical line basic information.

22. The method of claim 21, wherein the vertical line connection information is generated by checking whether or not each of vertical lines in the character string image is touched by neighboring vertical lines in adjacent columns.

23. The method of claim 22, wherein the vertical line connection information refer to vertical line ID information of vertical lines adjacent to left/right of each vertical line in the input character string image converted into vertical lines.

24. The method of claim 21, wherein the vertical line basic information refer to position information of each vertical line in a character string image, i.e., a column coordinate value and a top/bottom line coordinate value of each vertical line in the input character string image converted into the vertical lines.

25. The method of claim 21, wherein the vertical line is generated by vertically searching each pixel in the input character string image and connecting a range of consecutive pixels in the image.

26. The method of claim 20, wherein the vertical line set information refer to vertical line ID group information (line_id) on groups composed of vertical lines having a connection relation each other in the input character string image converted into the vertical lines in accordance with the vertical line connection information.

27. The method of claim 26, wherein the vertical line set information further includes a position information of a zone of a corresponding group in a character string image including the group of vertical line IDs.

28. The method of claim 27, wherein the group zone position information has a left top position information value and a right bottom position information value of a quadrilateral zone including the group of vertical line ID pixels in the character string image.

29. The method of claim 20, wherein the step (c′2) further comprises the steps of:
(c′21) generating vertical line characteristics information by using the vertical line information;
(c′22) determining types of vertical lines based on the vertical line characteristics; and
(c′23) composing vertical line sets of vertical lines having similar vertical line types and adjacent to each other by analyzing the determined vertical line type and vertical line connection information.

30. The method of claim 20, wherein the step (c′3) further comprises the steps of:
(c′31) merging a small vertical line set into an adjacent vertical line set by examining sizes of vertical line sets based on vertical line set information;
(c′32) generating vertical line set characteristics information, i.e., basic information for merging and separating vertical line sets, by examining characteristics of the merged vertical line sets; and
(c′33) merging and separating vertical line sets by analyzing the vertical line set characteristics information.

31. The method of claim 30, wherein the vertical line set characteristics information are generated by comparing a position, a size, a shape, a connection relation and the like of each vertical line set with those of other vertical lines sets.

32. The method of claim 20, wherein the image segmentation path graphs generating vertical line sets representing segment image candidates are generated by variously combining the estimated image segmentation positions are generated by combining each of the image segmentation positions.

33. The method of claim 20, wherein the individual segment image information are extracted from the character string image in accordance with the image segmentation path graphs based on the image segmentation candidate positions.
